(19) United States
(12) Patent Application Publication
(10) Pub. No.: US 2025/0052969 A1
(43) Pub. Date: Feb. 13, 2025

(54) OPTICAL FIBER CABLE HAVING HIGH TENSILE STRENGTH AND HEAT DISTRIBUTING ARMOR LAYER

(71) Applicant: CORNING RESEARCH & DEVELOPMENT CORPORATION, Corning, NY (US)

(72) Inventors: Andrii Kovalchuk, Lodz (PL); Sebastian Olszewski, Aleksandrów (PL); Akshay Parmar, Pune (IN); Girish Arun Saigaonkar, Pune (IN)

(21) Appl. No.: 18/925,646

(22) Filed: Oct. 24, 2024

Related U.S. Application Data
(63) Continuation of application No. PCT/US2023/019690, filed on Apr. 25, 2023.
(60) Provisional application No. 63/338,187, filed on May 4, 2022.

(51) Int. Cl. G02B 6/44

(52) U.S. Cl. CPC G02B 6/4433; G02B 6/4434; G02B 6/4436

(57) ABSTRACT

Embodiments of the disclosure relate to an optical fiber cable. The optical fiber cable includes an outer jacket having a first inner surface and a first outer surface. The optical fiber cable also includes an inner jacket. An armor layer is disposed between the outer jacket and the inner jacket. The armor layer is formed from a strip wrapped into a tubular structure around the inner jacket, and the strip is made from a material having a thermal conductivity of at least 10 W/mK. At least one layer of strengthening yarns is disposed between the armor layer and the inner jacket. In the optical fiber cable, a plurality of optical fibers is disposed within the inner jacket. The optical fiber cable has a tensile strength of at least 50 kN.

### CROSS-REFERENCE TO RELATED APPLICATIONS

This application is a continuation of International Application No. PCT/US2023/019690, filed Apr. 25, 2023, which claims the benefit of priority of U.S. Provisional Application Ser. No. 63/338,187 filed on May 4, 2022, the content of which is relied upon and incorporated herein by reference in its entirety.

### BACKGROUND

The disclosure relates generally to optical fiber cables and, in particular, to optical fiber cables including an armor layer having a high thermal conductivity positioned between two jacket layers. Optical fiber cables are deployed in a variety of different operating environments, including aerial, subterranean, underwater, and over the ground. The optical fiber cable must be configured to withstand the conditions of its respective environment. This can involve exposure to extreme temperature (hot or cold), tensile forces, corrosive agents, rodents, fire, and weather, among others. The cable construction can vary to account for the conditions to which the optical fiber cable is exposed with the general goal of maintaining optical transmission despite being subjected to the harshest conditions of that environment, even if such conditions may be rare.

### SUMMARY

According to an aspect, embodiments of the disclosure relate to an optical fiber cable. The optical fiber cable includes an outer jacket having a first inner surface and a first outer surface. The first outer surface defines an outermost surface of the optical fiber cable, and the first inner surface defines a first central bore extending along a longitudinal axis of the optical fiber cable. The optical fiber cable also includes an inner jacket disposed within the first central bore. The inner jacket has a second inner surface and a second outer surface, and the second inner surface defines a second central bore extending along the longitudinal axis. An armor layer is disposed in the first central bore between the first inner surface of the outer jacket and the second outer surface of the inner jacket. The armor layer is formed from a strip wrapped into a tubular structure around the inner jacket, and the strip is made from a material having a thermal conductivity of at least 10 W/mK. At least one layer of strengthening yarns is disposed in the first central bore between the armor layer and the second outer surface of the inner jacket. In the optical fiber cable, a plurality of optical fibers is disposed within the second central bore. The optical fiber cable has a tensile strength of at least 50 kN.

According to another aspect, embodiments of the disclosure relate to an optical fiber cable. The optical fiber cable includes a plurality of buffer tubes. Each of the plurality of buffer tubes contains at least one optical fiber. A first polymeric jacket is disposed around the plurality of buffer tubes, and the first polymeric jacket has a first thickness. An armor layer is disposed around the first polymeric jacket, and the armor layer forms a continuous layer around the first polymeric jacket. A second polymeric jacket is disposed around the armor layer, and the second polymeric jacket is an outermost layer of the optical fiber cable. The second polymeric jacket has a second thickness that is greater than the first thickness. When the optical fiber cable is contacted with a steel block having a length of 150 mm, a width of 150 mm, and a thickness of 10 mm and a temperature of 700° C. for 60 seconds, none of the plurality of buffer tubes melts. Further, the optical fiber cable has a tensile strength of at least 50 kN.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a cross-sectional view of an optical fiber cable, according to an exemplary embodiment;

FIG. 2 depicts a cross-sectional view of another optical fiber cable, according to an exemplary embodiment;

FIG. 3A depicts the temperature profile of the optical fiber cable of FIG. 2 after undergoing a simulated hot steel block test, according to an exemplary embodiment;

FIGS. 3B and 3C depict the temperature profiles of comparative cables after undergoing a simulated hot steel block test;

FIG. 4 provides a reference guide for maximum and average temperature measurements for various regions of the optical fiber cables of FIGS. 3A-3C; and

FIG. 5 is a graph of the temperature of a particular buffer tube during the course of the hot steel block test.

### DETAILED DESCRIPTION

Referring generally to the figures, various embodiments of an optical fiber cable configured to effectively distribute heat around the circumference of a high thermal conductivity armor layer are provided. As will be discussed more fully below, the optical fiber cable is configured to be laid over the ground adjacent to railroad tracks. In this environment, the optical fiber cable is not only exposed to the ambient environment in terms of temperature, weather, and wildlife but also to debris thrown off by trains traveling along the track. One particular form of debris is damaged brake plates that may fall from the train during an emergency braking situation. Such brake plates may be at a temperature of around 700° C. According to the present disclosure, the optical fiber cable is configured to withstand an exposure to such high temperature debris and maintain optical transmission. Further, the optical fiber cable is configured to have a high tensile strength of at least 50 kN to facilitate deployment from a train traveling along the track and prevent or limit damage to the optical fibers caused by rodents. Exemplary embodiments of such an optical fiber cable will be described in greater detail below and in relation to the figures provided herewith, and these exemplary embodiments are provided by way of illustration, and not by way of limitation.

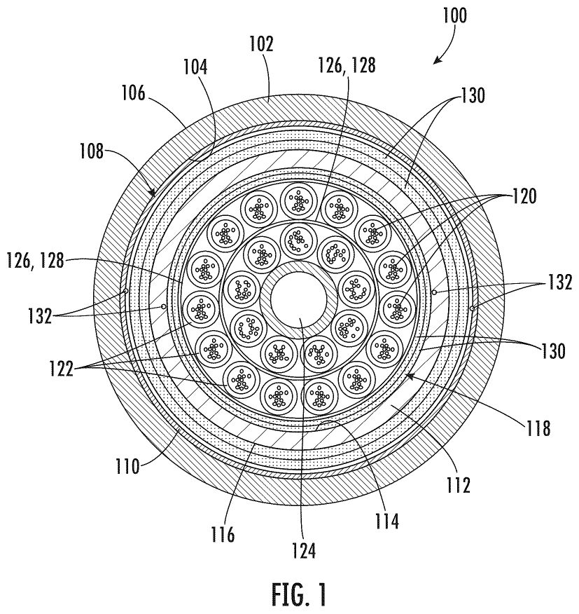

FIG. 1 depicts an example embodiment of an optical fiber cable 100. The optical fiber cable 100 includes an outer jacket 102 having a first inner surface 104 and a first outer surface 106. The first outer surface 106 is the outermost surface of the optical fiber cable 100. The first inner surface 104 defines a first central bore 108. Disposed within the first central bore 108 is at least one armor layer 110 and an inner jacket 112. The inner jacket 112 is a longitudinally continuous and circumferentially contiguous polymeric tube extending along the length of the optical fiber cable 100 for at least the same length as the armor layer 110. The inner jacket 112 includes a second inner surface 114 and a second outer surface 116. According to embodiments of the present disclosure, the armor layer 110 is disposed between the first inner surface 104 of the outer jacket 102 and the second outer surface 116 of the inner jacket 112.

The second inner surface 114 of the inner jacket 112 defines a second central bore 118. Disposed within the second central bore 118 are one or more optical fibers 120. In one or more embodiments, including the embodiment of FIG. 1, the optical fibers 120 are contained within buffer tubes 122 in a loose tube configuration. In one or more embodiments, the buffer tubes 122 are stranded in one or more layers around a central strength member 124. In the embodiment depicted in FIG. 1, there are two layers of buffer tubes 122 stranded around the central strength member 124. The first layer includes nine buffer tubes 122, and the second layer includes fifteen buffer tubes 122. Further, in the embodiment depicted, each buffer tube 122 contains twelve optical fibers 120, and thus, in the embodiment of the optical fiber cable 100 depicted in FIG. 1, there are 288 optical fibers 120.

In one or more other embodiments, the optical fiber cable 100 includes from one to thirty-six buffer tubes 122, in particular from six to thirty-six buffer tubes. In one or more other embodiments, each buffer tube 122 contains from one to thirty-six optical fibers 120. In one or more embodiments, the buffer tubes 122 may have an inner diameter in a range of from 1.5 mm to 2 mm, in particular about 1.7 mm. In one or more embodiments, the buffer tubes 122 have an outer diameter in a range from 2 mm to 2.5 mm, in particular about 2.25 mm. In one or more embodiments, the buffer tubes 122 are comprised of at least one polymer selected from, e.g., polyethylene (PE), polypropylene (PP), copolymers of PE and PP, polyamides (PA), polybutylene terephthalate (PBT), and polycarbonate (PC), among others. For example, the buffer tube 122 may include a composite structure of a layer of PBT around a layer of PC. In one or more embodiments, the buffer tubes 122 are comprised of at least one polymer having a melting temperature of 125° C. or more, 150° C. or more, 175° C. or more, or 200° C. or more.

In one or more embodiments, the optical fiber cable 100 may include a plurality of other components, such as one or more binding layers 126, one or more layers of water blocking tape 128, one or more layers of strengthening yarns 130, and one or more access features 132, disposed within either or both of the first central bore 108 and the second central bore 118. In the embodiment depicted in FIG. 1, the optical fiber cable 100 includes a first layer of buffer tubes 122 stranded around the central strength member 124. A binding layer 126 is disposed around the first layer of buffer tubes 122, and a layer of water blocking tape 128 is wrapped around the binding layer 126. A second layer of buffer tubes 122 is stranded around the first layer of buffer tubes 122. The second layer of buffer tubes 122 is surrounded by a binding layer 126, which is surrounded by another layer of water blocking tape 128. Disposed around the water blocking tape 128 is one or more layers of strengthening yarns 130, in particular two layers of strengthening yarns 130. The inner jacket 112 is disposed around the layer or layers of strengthening yarns 130. Further, the inner jacker 112 includes access features 132 disposed within the inner jacket 112 or between the inner jacket 112 and the strengthening yarns 130.

Disposed between the second outer surface 116 of the inner jacket 112 and the first inner surface 104 of the outer jacket 102 are one or more layers of strengthening yarns 130 (in particular two layers of strengthening yarns 130) that is surrounded by the armor layer 110. The outer jacket 102 may also include access features 132 disposed between the strengthening yarns 130 and the armor layer 110.

In one or more embodiments, each access feature 132 is a ripcord that can be grasped by a cable installer and pulled to tear through the armor layer 110 and outer jacket 102 or through the inner jacket layer 112. In one or more embodiments, the ripcord may be a filament of aramid fiber. In one or more embodiments, the water blocking tape 128 may be a strip of woven or nonwoven material impregnated with a superabsorbent polymer (SAP) resin or powder. In one or more embodiments, the water blocking tape 128 has a thickness of from 0.05 mm to 0.5 mm, in particular about 0.1 mm.

The strengthening yarns 130 contribute to the overall tensile strength of the optical fiber cable 100, and the strengthening yarns 130 provide thermal insulation to help prevent heat from transferring to the buffer tubes 122. In one or more embodiments, the strengthening yarns 130 are comprised of at least one of glass, aramid, basalt, liquid crystal polymer (LCP), carbon fibers, or silicon carbide fibers, among other possibilities. In one or more embodiments, each layer of strengthening yarns 130 has a thickness in a range from 0.1 mm to 0.5 mm, in particular about 0.3 mm. In one or more embodiments, the strengthening yarns 130 are stranded around the underlying cable components, and in one or more other embodiments, the strengthening yarns 130 are woven around the underlying cable components. In one or more embodiments, the minimum number of strengthening yarns 130 in each layer is selected to completely cover the underlying layer, and the maximum number of strengthening yarns 130 in each is layer is selected to provide the desired tensile strength of the optical fiber cable 100.

In one or more embodiments, the central strength member 124 includes a central member, such as a glass-(or other fiber-) reinforced plastic rod or a metal wire, which is optionally upjacketed with a layer of polymer, such as linear low density PE (LLDPE). In one or more embodiments, the central strength member 124 has a diameter selected based on the number of buffer tubes 122 stranded around it. In one or more embodiments, the diameter may be, e.g., up to 7 mm, and the central member may have a diameter of 60% to 100% of the diameter of the central strength member 124.

One or more embodiments of the optical fiber cable 100 are designed to have a tensile strength of at least 50 kN, and one or more other embodiments of the optical fiber cable 100 are designed to have a tensile strength of at least 100 kN. The optical fiber cable 100 can achieve these tensile strengths based on the selection of the type and number of layers of the strengthening yarns 130 as well as whether a central strength member 124 is included and its type. The other components of the optical fiber cable 100 contribute to the tensile strength of the optical fiber cable 100 as well, but the layers of strengthening yarns 130 and the central strength member 124 can be configured to increase the tensile strength of the optical fiber cable 100 to reach the desired level. In one or more embodiments, the optical fiber cable 100 may have a tensile strength of up to 150 kN. In one or more embodiments, the optical fiber cable 100 has at tensile strength of 50 kN or more, 100 kN or more, or up to 150 kN with 0.6% fiber strain or less. In one or more embodiments, the tensile strength of the optical fiber cable 100 is measured according to IEC 60794-1-21 E1. As mentioned above, the high tensile strength facilitates deployment of the optical fiber cable 100, including, e.g., from a moving train to lay the optical fiber cable 100 over the ground along the track.

Each armor layer 110 is formed from a strip or tape of flat material that is wrapped (either directly or indirectly) around the inner jacket 112 or the buffer tubes 122 such that longitudinal edges of the armor layer 110 meet, join, or overlap to form a tubular structure. In this way, the armor layer 110 is longitudinally continuous, circumferentially contiguous, and forms a longitudinal seam or overlap region along the length of the optical fiber cable 100. Further, in one or more embodiments, the longitudinal edges of the armor layer 110 may be welded at least partially along their length. As will be discussed more fully below, a continuous armor layer 110 operates as effective armor against rodent damage and also provides efficient thermal conductivity around the circumference of the armor layer 110. In one or more embodiments, each armor layer 110 may comprise a strip of material having a high thermal conductivity. In one or more embodiments, a high thermal conductivity is at least at least 10 W/mK, at least 40 W/mK, at least 70 W/mK, at least 100 W/mK, at least 150 W/mK, or at least 200 W/mK. In one or more embodiments, each armor layer 110 may comprise a metal, such as aluminum, steel, brass, or titanium, among other possibilities.

In one or more embodiments, each armor layer 110 may be corrugated. In one or more other embodiments, each armor layer 110 may be flat. In one or more embodiments, each armor layer 110 may be laminated. For example, the flat material of each metal armor layer 110 may be laminated with another material, such as a polymer (e.g., a PE), to enhance adhesion to the outer jacket 102 or the inner jacket 112. In one or more embodiments, each armor layer 110 may be made from a flat material having a thickness in a range from 0.1 to 0.5 mm, in particular about 0.2 mm. The overall thickness of the armor layer 110 may be greater than the thickness of the flat material depending on whether corrugations are formed into the flat material and whether the flat material is a laminated structure. According to embodiments of the present disclosure, the armor layer 110 is not a plurality of wires stranded around interior components, which may effectively prevent against rodent damage but which may not effectively distribute heat around the circumference of the layer.

In one or more embodiments, each of the binding layer 126, the inner jacket 112, and the outer jacket 102 may be an extruded polymeric material. In one or more embodiments, the binding layer 126 is a relatively thin film extruded around the buffer tubes 122 to hold them in place around the central strength member 124 or around the underlying layer of buffer tubes 122. In one or more embodiments, the binding layer 126 has a thickness in a range from 0.01 to 0.1 mm, in particular about 0.05 mm. In one or more embodiments, the binding layer 126 is comprised of a polyethylene material, including LLDPE, among other possibilities. However, in one or more other embodiments, the binding layer 126 may instead be comprised of binder yarns, such as polyester, aramid, or glass binder yarns. In contrast to the strengthening yarns 130, the binder yarns generally do not form a complete layer around the underlying cable component. For example, the binding layer 126 may include one to three binder yarns stranded around the underlying components to hold them in place.

In one or more embodiments, the inner jacket 112 is extruded around the buffer tubes 122 and central strength member 124 to provide an interior protective jacket to protect the optical fibers 120 in the case that the outer jacket 102 is penetrated. In one or more embodiments, the inner jacket 112 has a thickness that is less than the thickness of the outer jacket 102. In one or more embodiments, the inner jacket 112 has a thickness in a range from 0.5 mm to 2 mm, in particular 0.75 mm to 1.75 mm, and particularly about 1 mm. In one or more embodiments, the inner jacket 112 is comprised of PE (in particular high density PE), PA, or PP, among other possibilities.

In one or more embodiments, the outer jacket 102 is extruded around all of the interior components of the optical fiber cable 100 and is the outermost layer of the optical fiber cable 100. As the outermost layer, the outer jacket 102 provides the first layer of protection against the environment for the optical fiber cable 100. In one or more embodiments, the outer jacket 102 has a thickness that is greater than the thickness of the inner jacket 112. In one or more embodiments, the outer jacket 102 has a thickness in a range from 1 mm to 3 mm, in particular in a range from 1.25 mm to 2.25 mm, and particularly about 1.5 mm. In one or more embodiments, the outer surface 106 of the outer jacket 102 defines a circumference of the optical fiber cable 100, and the circumference is in a range from 15 mm to 30 mm, in particular in a range from 20 mm to 25 mm. In one or more embodiments, the outer jacket 102 is comprised of PE (in particular high density PE), PA, or PP, among other possibilities.

As mentioned above, the armor layer 110 is configured to efficiently distribute heat around the circumference of the optical fiber cable 100 when the optical fiber cable 100 is exposed to high temperature debris in the environment. In particular embodiments, the optical fiber cable 100 may be laid over the ground such that the cable is lying on the ground, exposed to various environmental hazards. In a more particular context, the optical fiber cable 100 may be laid alongside train tracks, which already provide a network through a geographical region. That is, train tracks are designed to connect various hubs throughout a country, and laying optical fiber cables 100 alongside the train tracks would provide a cost effective way to optically transmit data throughout a country. However, because the optical fiber cable 100 will be exposed to the environment near to a train track, the optical fiber cable 100 must be able to remain operational despite exposure to hazards, such as hot debris, that may be thrown off from a train traveling along the train track.

In particular, during an emergency braking action, brake plates of the train may be damaged and fall from the train, potentially landing on the optical fiber cable 100. To simulate this possibility, optical fiber cables 100 running along a train track are subjected to a “hot steel block” test in which a block of steel having the dimensions of 150 mm long, 150 mm wide, and 10 mm thick at 700° C. is placed on the optical fiber cable 100 for 60 seconds. To pass the test, the optical fiber cable 100 must maintain optical transmission during and after the test. The heat from the hot steel block will transfer immediately to the outer jacket 102, and at 700° C., the heat will be enough to melt the outer jacket 102. According to the present disclosure, the armor layer 110 is configured distribute the heat around the circumference of the optical fiber cable 100 so that the heat is not locally concentrated and transferred radially inward to the cable core containing the buffer tubes 122 carrying the optical fibers 120. Conventional optical fiber cables having armor layers comprised of wires provided around the optical fiber cable do not effectively distribute heat around the cable, especially when even small air gaps are provided between the wires, and instead, the heat becomes concentrated in a localized spot, allowing the heat to transfer radially inward toward the optical fibers 120 in the cable core.

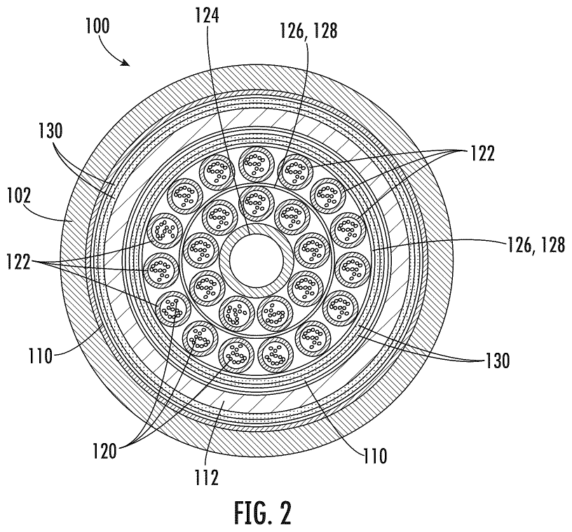

FIG. 2 depicts a particular embodiment of an optical fiber cable 100 used to simulate the heat transfer during a hot steel block test. In FIG. 2, the optical fiber cable 100 consisted of the following layers: (1) central strength member 124 having a glass-reinforced plastic rod with a diameter of 3.4 mm upjacketed with an LLDPE layer to 4.6 mm; (2) first layer of nine PC/PBT buffer tubes 122 (inner diameter of 1.7 mm, outer diameter 2.25 mm) with twelve optical fibers 120 in each buffer tube 122 providing a layer having an outer diameter of 9.1 mm; (3) binding layer 126 having a thickness of 0.05 mm; (4) layer of water blocking tape 128 having a thickness of 0.1 mm; (5) second layer of fifteen PC/PBT buffer tubes 122 (inner diameter of 1.7 mm, outer diameter of 2.25 mm) with twelve optical fibers 120 in each buffer tube 122 providing a layer having an outer diameter of 13.9 mm; (6) binding layer 126 having a thickness of 0.05 mm; (7) layer of water blocking tape 128 having a thickness of 0.1 mm; (8) two layers of glass strengthening yarns 130, each layer having a thickness of 0.3 mm, providing a total layer having an outer diameter of 15.4 mm; (9) corrugated and polymer laminated metal armor layer 110 formed from a flat steel tape having a thickness of 0.2 mm to provide a armor layer 110 with an outer diameter of 16.5 mm; (10) inner jacket 112 comprised of HDPE and having a thickness of 1 mm to provide a diameter of 18.5 mm; (11) two layers of glass strengthening yarns 130, each layer having a thickness of 0.3 mm, providing a total layer having an outer diameter of 19.7 mm; (12) corrugated and polymer laminated metal armor layer 110 formed from a flat steel tape having a thickness of 0.2 mm to provide a armor layer 110 with an outer diameter of 20.8 mm; and (13) outer jacket 102 comprised of HDPE and having a thickness of 1.5 mm to provide an optical fiber cable 100 having an outer diameter of 23.8 mm.

The heat transfer of the example embodiment of FIG. 2 during a simulated hot steel test was compared to a first optical fiber cable having an armor layer comprised of a plurality of steel wires, each wire having a diameter of 1.2 mm. The first comparative cable included a central strength member surrounded by a first layer of buffer tubes, a first layer of water blocking tape, a second layer of buffer tubes, a second layer of water blocking tape, an inner jacket, the armor layer of steel wires, and an outer jacket. In the armor layer, a small air gap (0.1 mm) was present between adjacent wires of the plurality of steel wires. A second comparative cable was also considered. The second comparative had the same construction as the first comparative cable with the exception that the diameter of each steel wire in the armor layer was increased to 1.325 mm so that adjacent wires touched around the armor layer. These two comparative cables represent the extremes between a cable having an armor layer comprised of steel wires, i.e., none of the wires touching and all of the wires touching.

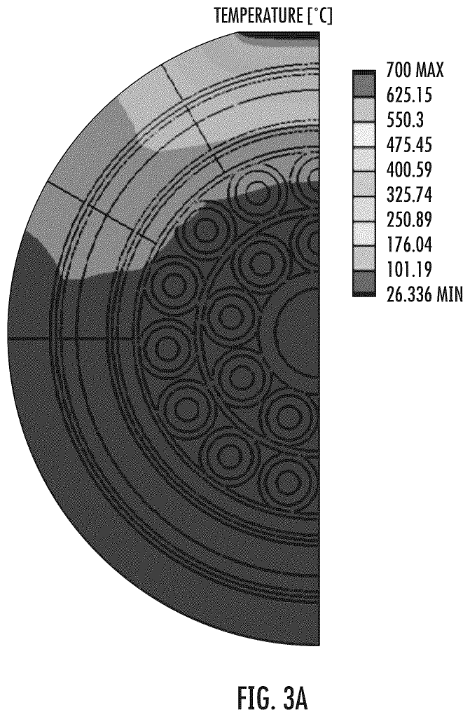

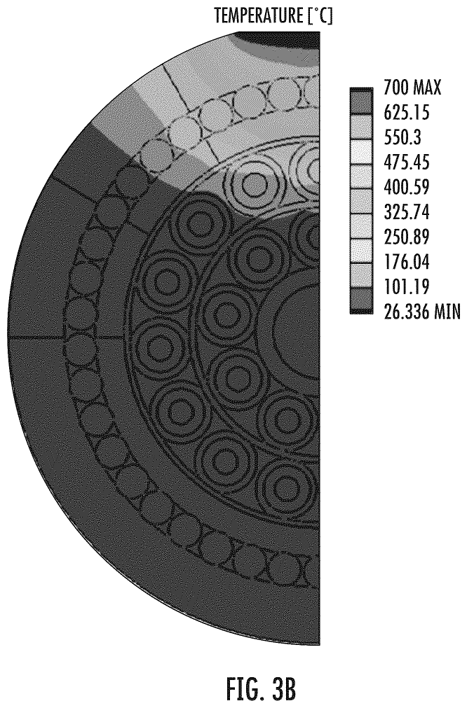

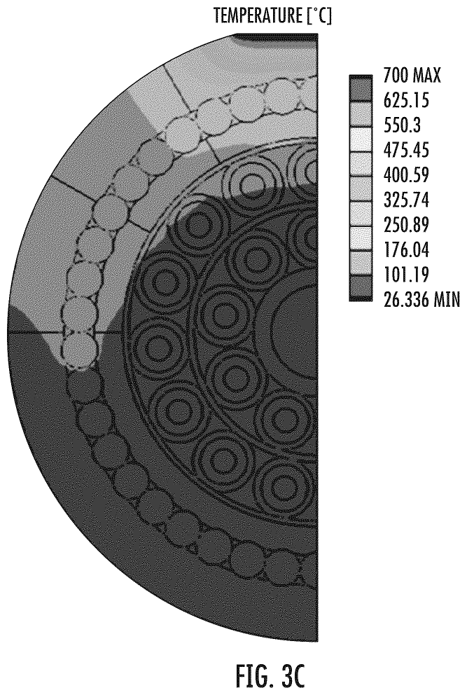

FIGS. 3A-3C depict the heat transfer of the example embodiment of the optical fiber cable 100 (FIG. 3A) as well as the heat transfer for the first and second comparative cables (FIGS. 3B and 3C). As can be seen for each of the three cables, the temperature of the cable is the hottest at the top where the hot steel block contacts each cable. In the cable according to the present disclosure shown in FIG. 3A, the heat from the hot steel plate is quickly dissipated circumferentially around the two metal armor layers 110 such that the heat does not concentrate and transfer radially inwardly toward the buffer tubes 122 carrying the optical fibers 120. In contrast, the steel wires of the armor layer in the first comparative cable as shown in FIG. 3B concentrate the heat locally where the hot steel plate contacts the cable. As can be seen in FIG. 3B, the buffer tubes in the outer layer reach a much higher temperature than the optical fiber cable 100 of FIG. 3A, and the heat from the steel plate even reaches the inner layer of buffer tubes. In the second comparable cable shown in FIG. 3C, the contact between the steel wires helps to spread the heat out circumferentially such that less heat is transferred radially inward than the first comparable cable. However, the buffer tubes in the outer layer reach a higher temperature than in the embodiment of the optical fiber cable 100 (FIG. 3A) according to the present disclosure.

The combined thickness of the armor layers 110 in the optical fiber cable 100 is 0.4 mm, whereas the steel wires of the armor layers of the comparable cables are 1.2 mm and 1.325 mm, respectively. Even including the additional layers of strengthening yarns 126, the overall diameter of the optical fiber cable 100 is not substantially increased. Notwithstanding, the heat dissipation of the disclosed optical fiber cable 100 is better than the comparative cables.

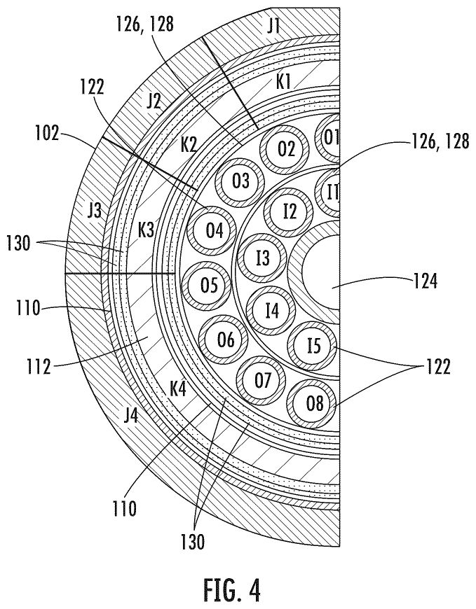

Tables 1-3 provide simulated temperatures for various regions of the cables having undergone the hot steel block test. The regions of the cable are identified in FIG. 4, which are four regions (J1-J4) of the outer jacket 102, four regions (K1-K4) in the inner jacket, eight (O1-O8) of the buffer tubes 122 in the outer layer, and five (I1-I5) of the buffer tubes 122 in the inner layer. FIG. 3 depicts half of the optical fiber cable 100, and the other half is expected to experience symmetric heat transfer. Table 1 provides the maximum and average temperature for the optical fiber cable 100 according to the present disclosure in each of these regions. The maximum temperature is the maximum temperature measured in the particular region, and the average temperature is the average temperature of the region at the 60th second. Region J1 of the outer jacket 102, region K1 of the inner jacket 112, outer buffer tubes 122 O1 and O2, and inner buffer tube 122 I1 are the directly below the hot steel plate during testing. As can be seen, those regions experience the highest temperatures, i.e., most heat transfer.

TABLE 1
Heat Transfer through Example Embodiment of Optical Fiber Cable

| Cable Part | Location | Max. Temp. (° C.) | Avg. Temp. (° C.) |
|---|---|---|---|
| Outer Jacket | J1 | 700 | 407 |
| Outer Jacket | J2 | 231 | 166 |
| Outer Jacket | J3 | 128 | 97 |
| Outer Jacket | J4 | 80 | 40 |
| Inner Jacket | K1 | 285 | 217 |
| Inner Jacket | K2 | 210 | 152 |
| Inner Jacket | K3 | 129 | 100 |
| Inner Jacket | K4 | 82 | 53 |
| Outer Buffer Tube | O1 | 147 | 112 |
| Outer Buffer Tube | O2 | 138 | 106 |
| Outer Buffer Tube | O3 | 115 | 87 |
| Outer Buffer Tube | O4 | 90 | 69 |
| Outer Buffer Tube | O5 | 69 | 54 |
| Outer Buffer Tube | O6 | 54 | 43 |
| Outer Buffer Tube | O7 | 44 | 37 |
| Outer Buffer Tube | O8 | 40 | 34 |
| Inner Buffer Tube | I1 | 62 | 47 |
| Inner Buffer Tube | I2 | 52 | 42 |
| Inner Buffer Tube | I3 | 41 | 34 |
| Inner Buffer Tube | I4 | 32 | 29 |
| Inner Buffer Tube | I5 | 28 | 27 |

From Table 1, it can be seen that region J1 of the outer jacket 102 has a maximum temperature of 700° C. and an average temperature of 407° C., which are both well above the melting temperature of the outer jacket 102 when made of HDPE. Thus, as expected, the hot steel block will melt through the outer jacket 102 at least in region J1. Region J2 experiences a maximum temperature of 231° C. but only an average temperature of 166° C. such that region J2 might also be melted by the hot steel block. As the circumferential distance from region J1 increases, the maximum and average temperatures decrease (max: 128° C. and 80° C. and avg: 97° C. and 40° C., respectively), such that regions J3 and J4 are unlikely to be substantially damaged by the hot steel bock.

In the inner jacket 112, the maximum temperature is greatly decreased from the maximum temperature of the outer jacket 102 because of the heat distribution effect provided by the armor layer 110 and because of the insulation provided by the strengthening yarns 130. In the region K1 that is directly beneath region J1 of the outer jacket 102, the maximum temperature is reduced to 285° C., and the average temperature is 217° C., which would both still be high enough to melt an inner jacket 112 of HDPE. The temperature decreases as the circumferential distance from region K1 increases. In particular, the maximum temperature drops to 210° C., 129° C., and 82° C. in regions K2-K4, and the average temperature drops to 152° C., 100° C., and 53° C. in those regions. Thus, the inner jacket 112 might also melt in the region K2, but will likely not be substantially damaged in regions K3 and K4.

In the outer buffer tubes 122, the heat from the hot steel block will be sufficiently circumferentially distributed that the buffer tubes 122 will not be damaged or melt. In particular, for a PC/PBT buffer tube, the melting temperature is around 220° C., and the maximum temperature in the outer buffer tubes 122 (buffer tube O1) is 147° C. (with an average temperature of 112° C.). The maximum and average temperatures decrease as the circumferential distance from buffer tube O1 increases. By buffer tube O4, the maximum temperature has decreased below 100° C. In the inner buffer tubes 122, all of the buffer tubes (I1-I5) remain below 100° C., and indeed, the maximum temperature reached is only 62° C. in buffer tube I1. Accordingly, none of the outer buffer tubes 122 or inner buffer tubes 122 are likely to be damaged when the optical fiber cable 100 is contacted with a hot steel block, such as a brake plate of a train.

Notably, the temperature of all the buffer tubes 122 in the inner and outer layer is increased from room temperature (25° C.), indicating that the armor layer or layers 110 are effective at circumferentially distributing the heat around the cable 100. As will be shown below, many portions of the first comparative cable do not change temperature from room temperature, indicating that the heat is concentrated locally below where the hot steel block contacts the comparative cable.

TABLE 2
Heat Transfer through the First Comparative Cable

| Cable Part | Location | Max. Temp. (° C.) | Avg. Temp. (° C.) |
|---|---|---|---|
| Outer Jacket | J1 | 700 | 446 |
| Outer Jacket | J2 | 251 | 124 |
| Outer Jacket | J3 | 54 | 34 |
| Outer Jacket | J4 | 26 | 25 |
| Inner Jacket | K1 | 499 | 366 |
| Inner Jacket | K2 | 218 | 114 |
| Inner Jacket | K3 | 51 | 33 |
| Inner Jacket | K4 | 26 | 25 |
| Outer Buffer Tube | O1 | 323 | 231 |
| Outer Buffer Tube | O2 | 233 | 166 |
| Outer Buffer Tube | O3 | 85 | 65 |
| Outer Buffer Tube | O4 | 36 | 31 |
| Outer Buffer Tube | O5 | 26 | 25 |
| Outer Buffer Tube | O6 | 25 | 25 |
| Outer Buffer Tube | O7 | 25 | 25 |
| Outer Buffer Tube | O8 | 25 | 25 |
| Inner Buffer Tube | I1 | 110 | 71 |
| Inner Buffer Tube | I2 | 60 | 44 |
| Inner Buffer Tube | I3 | 30 | 27 |
| Inner Buffer Tube | I4 | 25 | 25 |
| Inner Buffer Tube | I5 | 25 | 25 |

From Table 2, it can be seen that the heat in outer jacket of the first comparative cable is concentrated in regions J1 and J2. Indeed, region J3 only reaches a maximum temperature of 54° C. Similarly, in the inner jacket, the heat in the first comparative cable is concentrated in the first two regions K1 and K2, and the temperature is significantly higher than in the cable according to the present disclosure. In particular, in regions K1 and K2, the first comparative cable has maximum temperatures of 499° C. and 218° C. and average temperatures of 366° C. and 114° C. In contrast, the maximum temperature in regions K1 and K2 of the inner jacket 112 of the disclosed optical fiber cable 100 was 285° C. and 210° C., respectively, with average temperatures of 217° C. and 152° C. Similarly, the maximum and average temperatures in the outer buffer tubes O1 and O2 are significantly higher than in the presently disclosed optical fiber cable 100. In particular, both the maximum temperatures of 323° C. for buffer tube O1 and of 233° C. for buffer tube O2 are higher than the melting temperature of the PC/PBT material of the buffer tubes. In this regard, the buffer tubes are likely to be deformed, which is likely to affect optical transmission of the optical fibers contained therein. Specifically, the buffer tubes may deform to contact the optical fibers creating attenuation during transmission. Further, even if the buffer tubes do not immediately cause attenuation, subsequent cooling or warming of the deformed buffer tube (e.g., during the winter and summer months) can cause the deformed buffer tube to expand or contract in ways that cause attenuation of the optical fibers.

TABLE 3
Heat Transfer through the Second Comparative Cable

| Cable Part | Location | Max. Temp. (° C.) | Avg. Temp. (° C.) |
|---|---|---|---|
| Outer Jacket | J1 | 700 | 315 |
| Outer Jacket | J2 | 221 | 165 |
| Outer Jacket | J3 | 145 | 120 |
| Outer Jacket | J4 | 107 | 77 |
| Inner Jacket | K1 | 224 | 190 |
| Inner Jacket | K2 | 186 | 151 |
| Inner Jacket | K3 | 145 | 114 |
| Inner Jacket | K4 | 107 | 73 |
| Outer Buffer Tube | O1 | 161 | 123 |
| Outer Buffer Tube | O2 | 148 | 114 |
| Outer Buffer Tube | O3 | 120 | 92 |
| Outer Buffer Tube | O4 | 94 | 72 |
| Outer Buffer Tube | O5 | 76 | 59 |
| Outer Buffer Tube | O6 | 62 | 48 |
| Outer Buffer Tube | O7 | 54 | 43 |
| Outer Buffer Tube | O8 | 49 | 41 |
| Inner Buffer Tube | I1 | 68 | 50 |
| Inner Buffer Tube | I2 | 56 | 44 |
| Inner Buffer Tube | I3 | 43 | 35 |
| Inner Buffer Tube | I4 | 34 | 30 |
| Inner Buffer Tube | I5 | 29 | 28 |

The second comparative cable represents an idealized case for a wire stranded armor layer in which all of the wires are in contact with an adjacent wire. However, such a configuration is not realistic and indeed is not desired for practical reasons during manufacturing and use. Nevertheless, Table 3 demonstrates that the heat transferred to the buffer tubes in the outer layer is greater than in the cable according to the present disclosure. As mentioned above, the performance of an actual comparative cable is likely to be between what is shown in Table 2 (where none of the wires in the armor are touching) and in Table 3 (where all of the wires in the armor are touching) because at least some of the wires of the armor layer are likely to touch whereas others will not. However, the wires of the armor layer will not distribute heat around the cable cross-section as effectively as the armor layer 110 of the presently disclosed optical fiber cable 100 because air gaps between wires or groups of wires will inevitably be present at various points around the circumference of the wire armor layer.

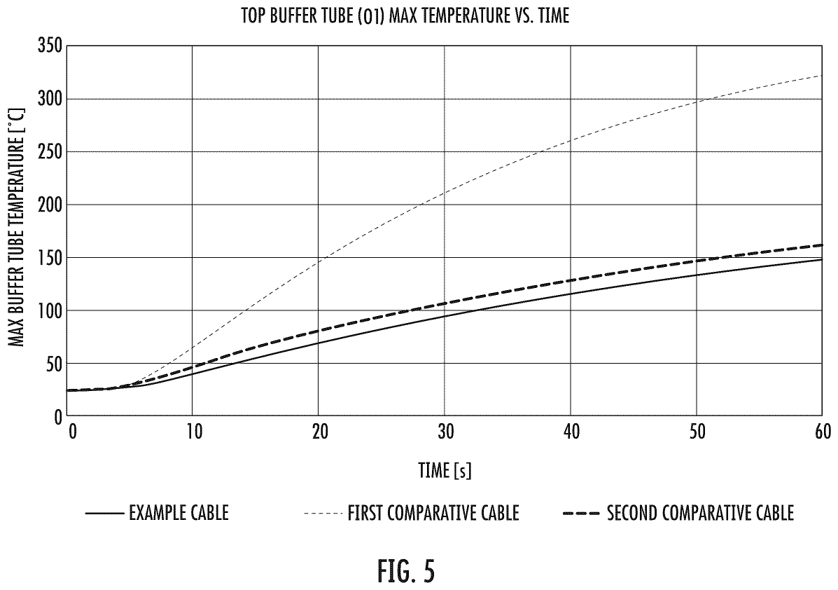

FIG. 5 depicts a graph of the maximum temperature of the buffer tube O1 for the example embodiment and the two comparative cables, which is the buffer tube closest to the portion of the cable contacted with the hot steel block. As can be seen, the temperature of the buffer tube O1 for the first comparative cable after 60 seconds is over 300° C. The lowest temperature of the buffer tube O1 is in the example embodiment of the optical fiber cable 100 in which the temperature after 60 seconds is less than 150° C. While the ideal (for thermal conductivity) comparative cable structure performs much better than the other comparative cable structure, it is not realistic that the wires of the armor layer would all touch, and it still performs worse than the disclosed construction for the optical fiber cable 100.

In order to confirm the performance of the disclosed optical fiber cable 100, the inventors conducted a hot steel block test on an optical fiber cable 100 having the following construction: (1) central strength member 124 with a 3.4 mm glass-reinforced plastic rod upjacketed with LLDPE to 6.9 mm; (2) a layer of twelve gel-filled, PC/PBT buffer tubes 122 having an inner layer of PC (inner diameter of 1.7 mm; thickness of 0.115 mm) and an outer layer of PBT (outer diameter of 2.25 mm; thickness of 0.16 mm) with each buffer tube 122 having twelve optical fibers 120 (outer diameter of 252 μm); (3) binding layer 126 having a thickness of 0.05 mm; (4) layer of water-blocking tape 128 having a thickness of 0.1 mm; (5) LLDPE inner jacket 112 having a thickness of 1.7 mm; (6) layer of water-blocking tape 128 having a thickness of 0.1 mm; (7) laminated and corrugated armor layer 110 having a layer thickness 0.35 mm (including corrugations added to laminated strip of 0.05 mm plastic laminated to each side of steel strip with thickness of 0.15 mm); and (8) LLDPE outer jacket 102 having a thickness of 2 mm. Thus, the tested optical fiber cable 100 included one armor layer 110 disposed between the outer jacket 102 and the inner jacket 112. Further, the tested optical fiber cable 100 did not include layers of strengthening yarns 130. The absence of the strengthening yarns 130 would decrease the tensile strength of the cable, but the absence of their insulating effect serves to further demonstrate the effectiveness of the armor layer 110 (even a single armor layer 110) in distributing heat around the optical fiber cable 100.

After the hot steel block having the dimensions of 150 mm×150 mm×10 mm and a temperature of 700° C. was placed on the optical fiber cable 100 as described in the preceding paragraph for 60 seconds, the optical fiber cable 100 was opened to inspect the buffer tubes 122, and it was found that the buffer tubes 122 showed no signs of melting or otherwise being deformed. Therefore, the inventors expect that an optical fiber cable 100 constructed according to the present disclosure would be able to withstand contact from a hot brake plate that drops off a train during an emergency braking situation. Further, when provided with layers of strengthening yarns, the optical fiber cable 100 is expected to possess the tensile strength needed for various desired modes of deployment as well as the requisite defense against rodent damage for the given environment alongside railroad tracks.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
an outer jacket comprising a first inner surface and a first outer surface, the first outer surface defining an outermost surface of the optical fiber cable and the first inner surface defining a first central bore extending along a longitudinal axis of the optical fiber cable;
an inner jacket disposed within the first central bore, the inner jacket comprising a second inner surface and a second outer surface, the second inner surface defining a second central bore extending along the longitudinal axis;
an armor layer disposed in the first central bore between the first inner surface of the outer jacket and the second outer surface of the inner jacket, the armor layer being formed from a strip wrapped into a tubular structure around the inner jacket, the strip comprising a material having a thermal conductivity of at least 10 W/mK;
at least one layer of strengthening yarns disposed in the first central bore between the armor layer and the second outer surface of the inner jacket; and
a plurality of optical fibers disposed within the second central bore;
wherein the optical fiber cable has a tensile strength of at least 50 kN.

2. The optical fiber cable of claim 1, wherein the material of the strip is a metal.

3. The optical fiber cable of claim 2, wherein the metal comprises aluminum, steel, brass, or titanium.

4. The optical fiber cable of claim 1, wherein the at least one layer of strengthening yarns comprises yarns formed from glass fibers, basalt fibers, aramid fibers, liquid crystal polymer, carbon fibers, or silicon carbide fibers.

5. The optical fiber cable of claim 1, further comprising a second armor layer disposed in the second central bore between the second inner surface of the inner jacket and the plurality of optical fibers, the second armor layer being formed from a second strip wrapped into a tubular structure around the plurality of optical fibers, the second strip comprising a second material having a thermal conductivity of at least 10 W/mK.

6. The optical fiber cable of claim 5, further comprising a second layer of strengthening yarns disposed in the second central bore between the second armor layer and the plurality of optical fibers.

7. The optical fiber cable of claim 1, wherein the plurality of optical fibers is arranged in one or more buffer tubes and wherein, when the optical fiber cable is contacted with a steel block having a length of 150 mm, a width of 150 mm, and a thickness of 10 mm and a temperature of 700° C. for 60 seconds, none of the one or more buffer tubes melts.

8. The optical fiber cable of claim 1, wherein the outer jacket comprises a first thickness as measured between the first outer surface and the first inner surface, the first thickness being in a range from 1 mm to 3 mm.

9. The optical fiber cable of claim 8, wherein the inner jacket comprises a second thickness as measured between the second outer surface and the second inner surface, the second thickness being less than the first thickness and the second thickness being in a range from 0.5 mm to 2 mm.

10. The optical fiber cable of claim 9, wherein the first outer surface defines a diameter of the optical fiber cable, the diameter being from 15 mm to 30 mm.

11. An optical fiber cable, comprising:
a plurality of buffer tubes, each of the plurality of buffer tubes containing at least one optical fiber;
a first polymeric jacket disposed around the plurality of buffer tubes, the first polymeric jacket having a first thickness;
an armor layer disposed around the first polymeric jacket, the armor layer forming a continuous layer around the first polymeric jacket;
a second polymeric jacket disposed around the armor layer, the second polymeric jacket being an outermost layer of the optical fiber cable and the second polymeric jacket having a second thickness that is greater than the first thickness;
wherein, when the optical fiber cable is contacted with a steel block having a length of 150 mm, a width of 150 mm, and a thickness of 10 mm and a temperature of 700° C. for 60 seconds, none of the plurality of buffer tubes melts; and
wherein the optical fiber cable comprises a tensile strength of at least 50 kN.

12. The optical fiber cable of claim 11, wherein the plurality of buffer tubes is stranded around a central strength member.

13. The optical fiber cable of claim 12, wherein the plurality of buffer tubes comprises a first layer of buffer tubes contacting the central strength member and a second layer of buffer tubes disposed between the first layer of buffer tubes and the first polymeric jacket.

14. The optical fiber cable of claim 13, wherein each buffer tube of the plurality of buffer tubes comprises an inner layer of polycarbonate and an outer layer of polybutylene terephthalate.

15. The optical fiber cable of claim 11, further comprising a first layer of strengthening yarns disposed between the first polymeric jacket and the armor layer.

16. The optical fiber cable of claim 15, further comprising a second layer of strengthening yarns disposed between the first polymeric jacket and the plurality of buffer tubes.

17. The optical fiber cable of claim 16, wherein the first layer of strengthening yarns and the second layer of strengthening yarns each comprise a thickness of 0.1 to 0.5 mm.

18. The optical fiber cable of claim 13, wherein the armor layer is formed from a strip comprising a material having a thermal conductivity of at least 10 W/mK.

19. The optical fiber cable of claim 11, wherein the tensile strength is at least 100 kN.

20. The optical fiber cable of claim 11, wherein each buffer tube of the plurality of buffer tubes comprises a polymer having a melting temperature of at least 125° C.
